(19) United States
(12) Patent Application Publication
(10) Pub. No.: US 2019/0026816 A1
(43) Pub. Date: Jan. 24, 2019

(54) Time-division Recommendation Method and Apparatus for Service Objects

(71) Applicant: Alibaba Group Holding Limited, Grand Cayman (KY)

(72) Inventor: Jun Zhou, Hangzhou (CN)

(21) Appl. No.: 16/140,308

(22) Filed: Sep. 24, 2018

Related U.S. Application Data
(63) Continuation of application No. PCT/CN2017/076549, filed on Mar. 14, 2017.

(30) Foreign Application Priority Data
Mar. 25, 2016 (CN) 201610180312.4

(51) Int. Cl. G06Q 30/06; H04L 29/08; G06Q 30/02

(52) U.S. Cl. CPC G06Q 30/0631; G06Q 30/0272; H04L 67/22

(57) ABSTRACT

A time-division recommendation method for service objects and an apparatus thereof are provided. The method includes obtaining a user activity log on a service platform; determining time periods of recommendation using the user activity log; separately configuring recommendation strategies for the time periods of recommendation; and recommending service objects to users in the time periods of recommendation using the recommendation strategies correspondingly. The embodiments of the present disclosure are used for satisfying in-depth needs of users, and improving the effects of recommendation of service objects of service platforms.

### CROSS REFERENCE TO RELATED PATENT APPLICATIONS

This application claims priority to and is a continuation of PCT Patent Application No. PCT/CN2017/076549 filed on 14 Mar. 2017, and is related to and claims priority to Chinese Patent Application No. 201610180312.4, filed on 25 Mar. 2016, entitled “Time-division Recommendation Method and Apparatus for Service Objects,” which are hereby incorporated by reference in their entirety.

### TECHNICAL FIELD

The present disclosure relates to the technical field of data processing technologies, and particularly to time-division recommendation methods and apparatuses for service objects.

### BACKGROUND

Marketing refers to conveying various types of information about a company and their products by a marketer to users, persuading or attracting the users to purchase the company's products to achieve the purpose of expanding sales volume. A marketing method that is commonly used by e-commerce platforms is to perform product promotions at festivals or certain scheduled times to encourage users to purchase products.

A traditional festival promotion plan refers to employing an e-commerce platform to provide a series of discounted products to users at discounted prices during a promotion period. During different promotion periods, products that are provided are fixed and unchanged. However, mindsets of users for purchases are different in different time periods. For example, when a product promotion is just started, and the product promotion time is assumed to start from 0 o'clock, users will rush to buy products at this time and purchase products that they have paid attention early. After 2 o'clock, the users have already purchased the products that they have paid attention too early. At this time, the intent of the users is weakened, and the users are very likely purchasing products randomly. Since recommended products are unchanged, a traditional scheme of product recommendation does not consider mindsets and shopping habits of users, and inevitably affect shopping experience of the users, thus failing to meet in-depth needs of the users, and reducing sales volumes of products of an e-commerce platform.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above problems, embodiments of the present disclosure are proposed to provide a time-division recommendation method for service objects and a corresponding time-division recommendation system for service objects to overcome the above problems or at least partially solve the above problems.

To solve the above problems, the embodiments of the present disclosure disclose a time-division recommendation method for service objects, which includes obtaining a user activity log on a service platform; determining time periods of recommendation using the user activity log; separately configuring recommendation strategies for the time periods of recommendation; and recommending service objects to users in the time periods of recommendation using the recommendation strategies correspondingly.

In implementations, the user activity log includes user activity data, and determining the time periods of recommendation using the user activity log includes using the user activity data to calculate degrees of activity of the users at various time points; and setting the time periods of recommendation based on the degrees of activity of the respective time points.

In implementations, recommending the service objects to the users in the time periods of recommendation using the recommendation strategies correspondingly includes obtaining user activity data of a certain user during a first specified time period, the user belonging to one or more user groups; determining first recommended object(s) based on the user activity data; determining second recommended object(s) of the user groups at a second specified time period; and recommending the first recommended object(s) and the second recommended object(s) for the user in a time period of recommendation.

In implementations, determining the first recommended object(s) based on the user activity data includes acquiring service object(s) corresponding to the user activity data; and setting the service object(s) as the first recommended object(s).

In implementations, determining the second recommended object(s) of the user groups at the second specified time period includes acquiring user activity data of the user groups at the second specified time period; counting a number of service objects corresponding to the user activity data; and setting first N number of service objects as the second recommended object(s), N being a positive integer.

In implementations, recommending the service objects to the users in the time periods of recommendation using the recommendation strategies correspondingly includes obtaining user activity data of a certain user during a third specified time period; determining third recommended object(s) according to the user activity data; randomly obtaining fourth recommended object(s) from a preset object database; and recommending the third recommended object(s) and the fourth recommended object(s) to the user in a time period of recommendation.

In implementations, recommending the service objects to the users in the time periods of recommendation using the recommendation strategies correspondingly includes obtaining user activity data of a certain user in a fourth specified period of time, the user activity data having corresponding service object(s); determining fifth recommended object(s) using the service object(s) according to a preset collaborative filtering algorithm; obtaining preset common service object(s) as sixth recommended object(s); and recommending the fifth recommended object(s) and the sixth recommended object(s) to the user in a time period of recommendation.

In implementations, the service platform is an e-commerce platform, the service objects are products, and the user activity data includes clicking activity data of the user for the products, no-clicking activity data, browsing activity data, adding-to-shopping-cart activity data, and collection activity data, and flow data.

The embodiments of the present disclosure also disclose a time-division recommendation apparatus for service objects, which includes a user activity log acquisition module configured to obtain a user activity log on a service platform; a recommendation time period determination module configured to determine time periods of recommendation using the user activity log; a recommendation strategy configuration module configured to separately configure recommendation strategies for the time periods of recommendation; and a service object recommendation module configured to recommend service objects to users in the time periods of recommendation using the recommendation strategies correspondingly.

In implementations, the user activity log includes user activity data, and the recommendation time period determination module includes an activity degree calculation sub-module configured to use the user activity data to calculate degrees of activity of the users at various time points; and a recommendation time period setting sub-module configured to set the time periods of recommendation based on the degrees of activity of the respective time points.

In implementations, the service object recommendation module includes a first user activity acquisition sub-module configured to obtain user activity data of a certain user during a first specified time period, the user belonging to one or more user groups; a first recommended object determination sub-module configured to determine first recommended object(s) based on the user activity data; a second recommended object determination sub-module configured to determine second recommended object(s) of the user groups at a second specified time period; and a first service object recommendation sub-module configured to recommend the first recommended object(s) and the second recommended object(s) for the user in a time period of recommendation.

In implementations, the first recommended object determination sub-module includes a service object acquisition unit configured to obtain service object(s) corresponding to the user activity data; and a first recommended object setting unit configured to set the service object(s) as the first recommended object(s).

In implementations, the second recommended object determination sub-module includes a user activity data acquisition unit configured to obtain user activity data of the user groups at the second specified time period; a service object quantity counting unit configured to count a number of service objects corresponding to the user activity data; and a second recommended object setting unit configured to set first N number of service objects as the second recommended object(s), N being a positive integer.

In implementations, the service object recommendation module includes a second user activity data acquisition sub-module configured to obtain user activity data of a certain user during a third specified time period; a third recommended object determination sub-module configured to determine third recommended object(s) according to the user activity data; a fourth recommended object determination sub-module configured to randomly obtain fourth recommended object(s) from a preset object database; and a second service object recommendation sub-module configured to recommend the third recommended object(s) and the fourth recommended object(s) to the user in a time period of recommendation.

In implementations, the service object recommendation module includes a third user activity data acquisition sub-module configured to obtain user activity data of a certain user in a fourth specified period of time, the user activity data having corresponding service object(s); a fifth recommended object determination sub-module configured to determine fifth recommended object(s) using the service object(s) according to a preset collaborative filtering algorithm; a sixth recommended object determination sub-module configured to obtain preset common service object(s) as sixth recommended object(s); and a third service object recommendation sub-module configured to recommend the fifth recommended object(s) and the sixth recommended object(s) to the user in a time period of recommendation.

The embodiments of the present disclosure include the following advantages.

The embodiments of the present disclosure utilize user activity log of a service platform to statistically analyze user activities of users on the service platform at different time periods, thereby configuring a series of recommendation strategies accordingly, and then recommending services objects to users based on the recommendation strategies. Since service objects are recommended to users based on time-division recommendation strategies, in-depth needs of the users are satisfied, thus improving the effectiveness of recommendation of service objects in a service platform.

A service platform and a service object in implementations may correspond to an e-commerce platform and a product respectively. Degrees of activity of users at various time points are calculated using a user activity log. Since the degrees of activity can reflect purchase mindsets and shopping habits of the users, time periods of recommendation can be set based on the degrees of activity. A time period of recommendation is configured with an adaptive recommendation strategy, and an adaptive recommendation strategy can be used to recommend products to a user in a corresponding time period of recommendation. Since a purchase mindset and a shopping habit of a user is considered in implementations, an in-depth need of the user is satisfied, and the effect of shopping experience of the user is improved, thus significantly increasing the sales volume of the e-commerce platform.

### BRIEF DESCRIPTION OF THE DRAWINGS

FIGS. 1A-1E are flowcharts of an embodiment of a time-division recommendation method for service objects in accordance with the present disclosure.

FIG. 2 is a schematic flowchart of a holiday product promotion in accordance with the present disclosure.

FIG. 3 is a structural block diagram of a time-division recommendation system for service objects in accordance with the present disclosure.

### DETAILED DESCRIPTION

To make the above objectives, features, and advantages of the present disclosure more comprehensible, the present disclosure is described in further detail hereinafter with reference to the accompanying drawings and particular implementations.

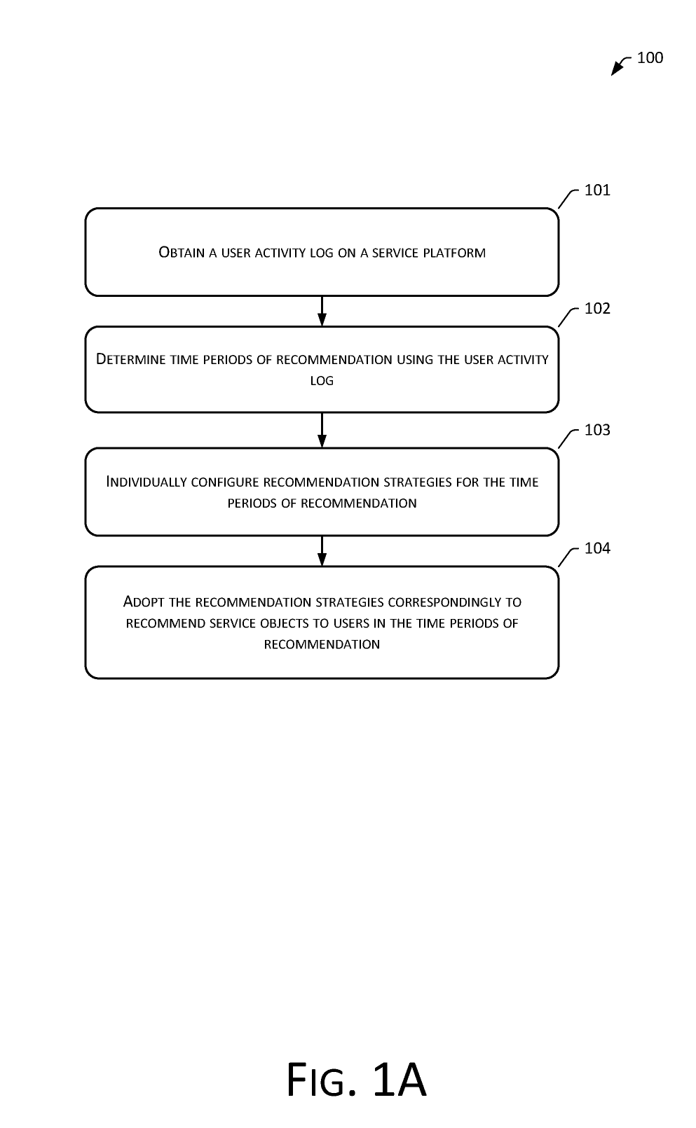

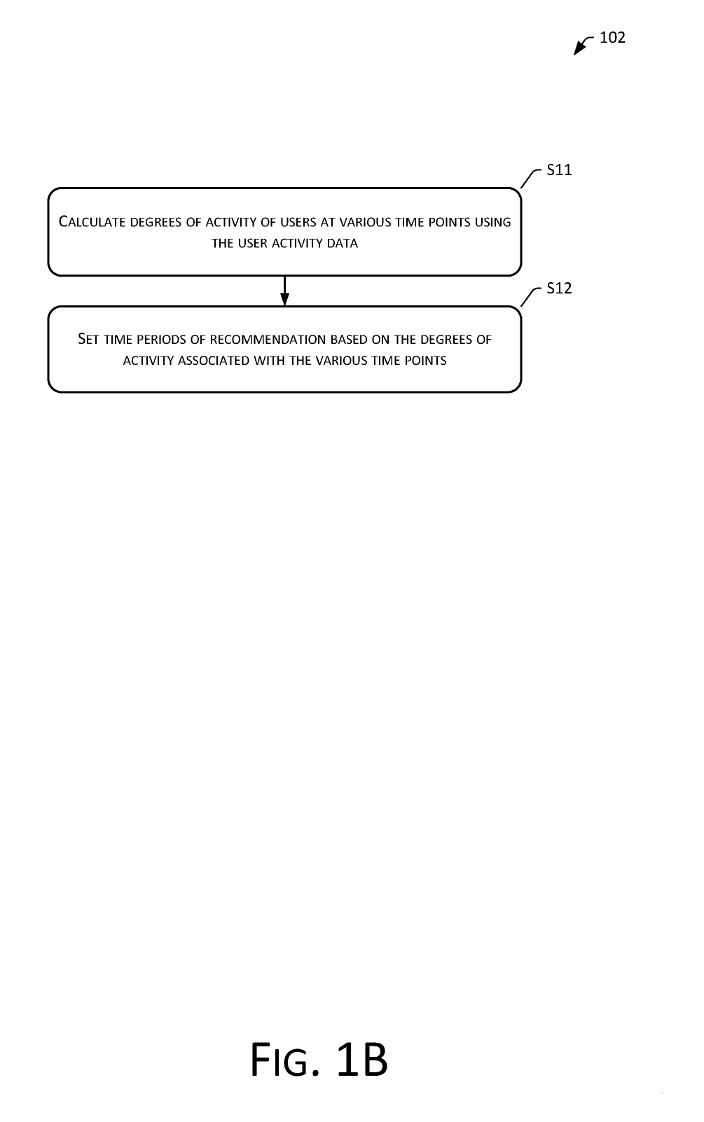

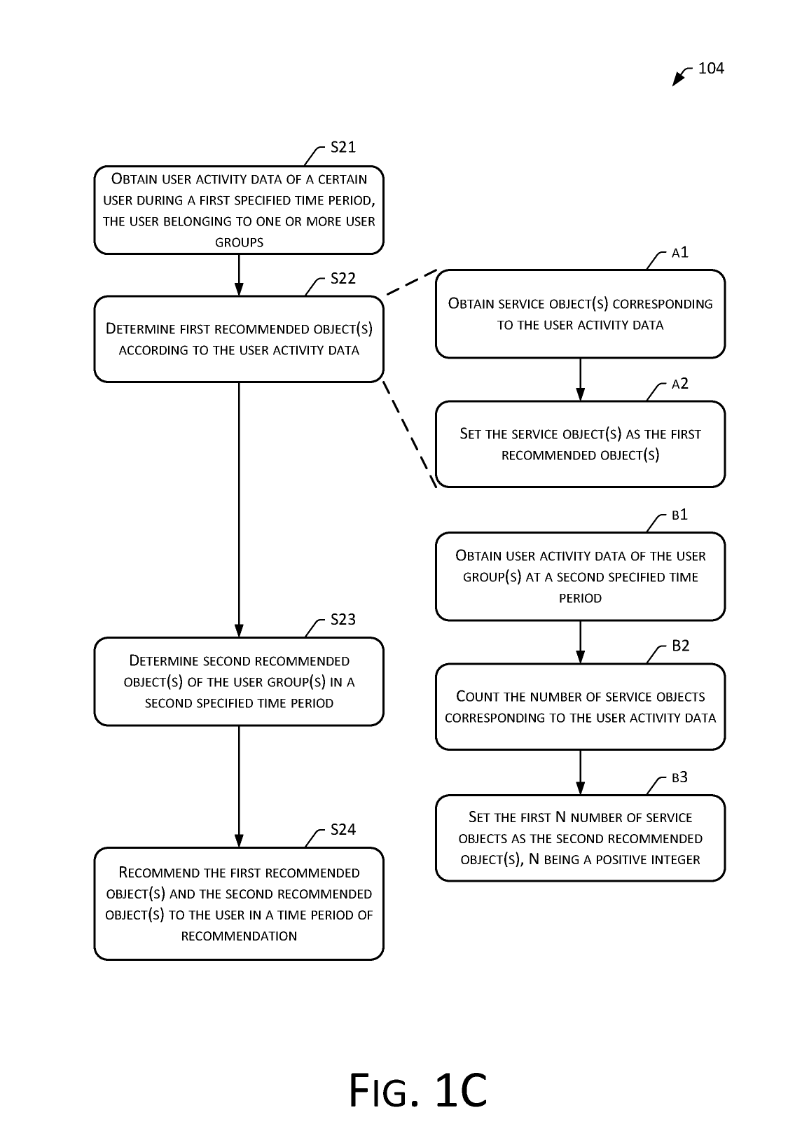

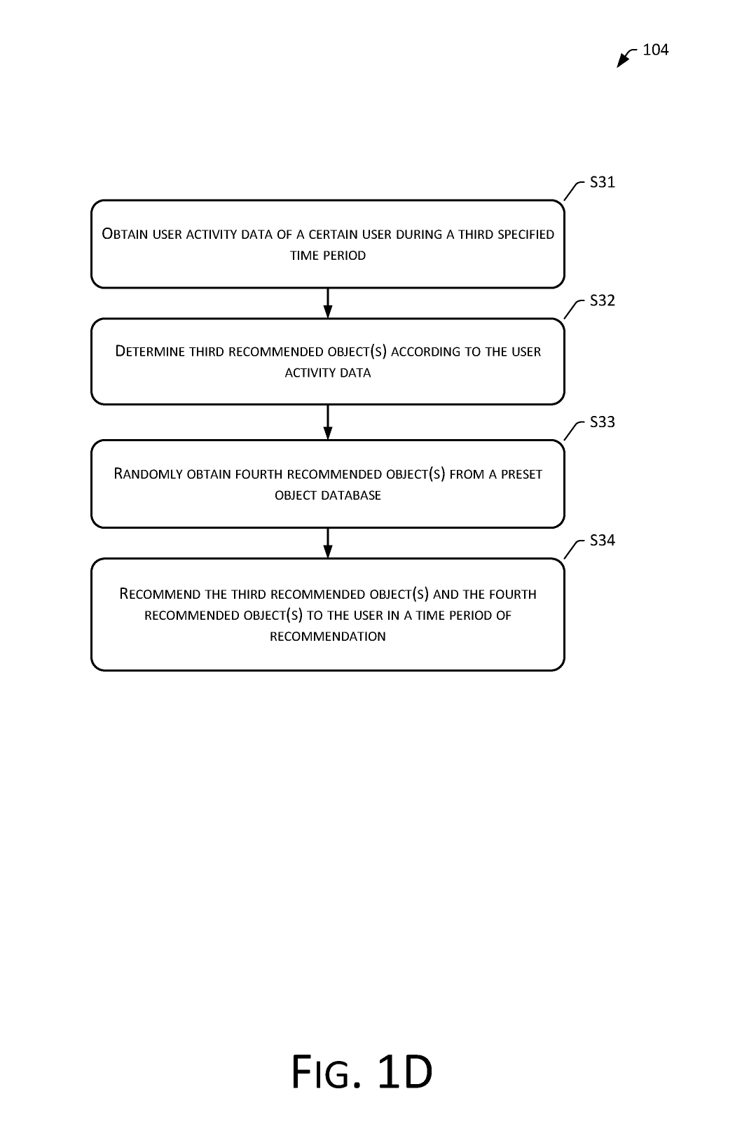

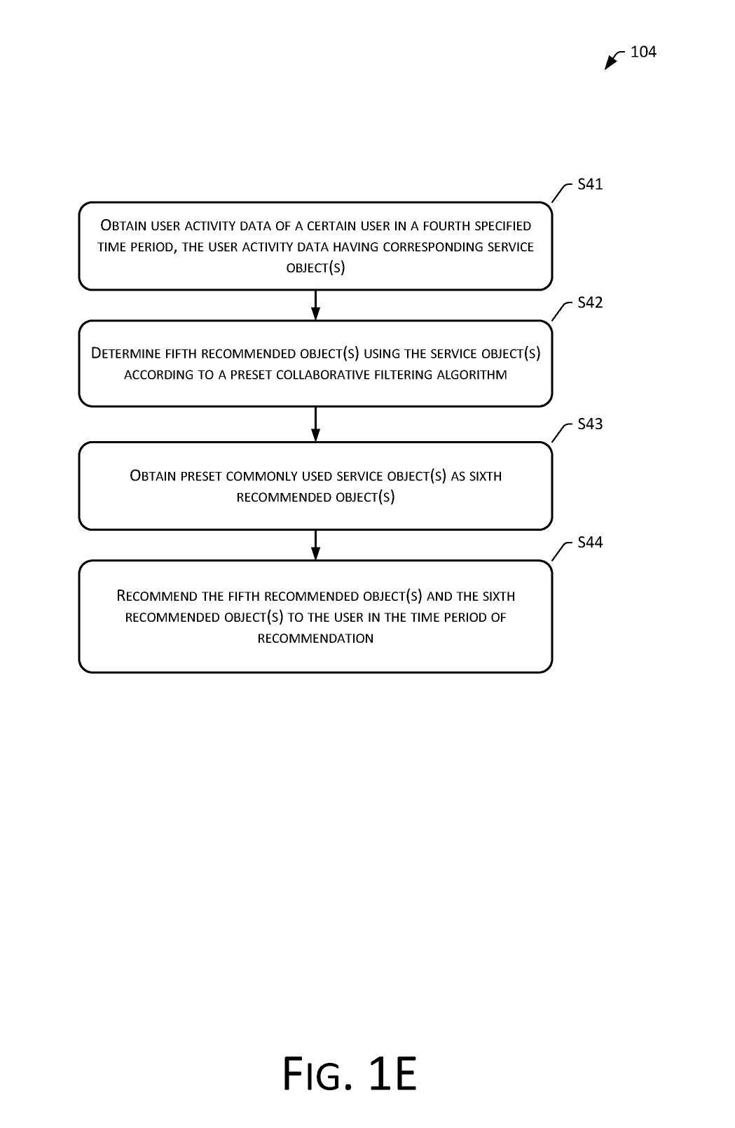

Referring to FIG. 1A, a flowchart of a time-division recommendation method 100 for service objects according to the present disclosure is shown, which may specifically include the following operations.

Operation 101: Obtain a user activity log on a service platform.

It should be noted that a service platform in implementations refers to an e-commerce platform, and a service object refers to a concrete object in different service areas on an e-commerce platform, such as a product. In order to make one skilled in the art to understand the embodiments of the present disclosure in a better way, a product is mainly used as an example of a service object in the present specification for illustration.

In implementations, products may be products of one or more types displayed by one or more e-commerce websites or e-commerce platforms. A product that is displayed has one or more pieces of product information, such as attributes of the product, which are, for example, an image of the product, a name of the product, a price of the product, a description of the product, a model of the product, or parameters of the product, etc.

In implementations, a user activity log is recorded in an e-commerce platform, and the user activity log includes user activity data of users and products, which is specifically clicking activities of the users, no-clicking activities, browsing activities, and add-to-shopping-cart activities, collection activities, and other interactive activity data, with respect to the products on the e-commerce platform. In addition, the user activity log can also include basic data of the users, which is specifically a very large number of dimensions of data such as genders, ages, cities, occupations or purchasing powers of the users.

A clicking activity refers to a user clicking to enter a homepage of a product displayed on a page of an e-commerce platform. It can be understood that many products are displayed on the page of the e-commerce platform, and a user usually does not click to enter homepages of all products. Therefore, a no-clicking activity means that a user has not clicked to enter a home page of a product displayed on a page of an e-commerce platform. A browsing activity means that a user browses a product of a page of an e-commerce platform, and/or clicks to enter a homepage of the displayed product to browse detailed information. Since an adding-to-shopping-cart activity and a collection activity are common practices for online shopping, they are not described in detail herein.

Apparently, the user activity data and the user basic data in the user activity log described above are merely examples. In implementations, certain data in the user activity log may be appropriately added or removed, which is not limited in implementations.

Operation 102: Determine time periods of recommendation using the user activity log.

In implementations, the user activity log may include user activity data, and operation 102 may include the following sub-operations as shown in FIG. 1B.

Sub-operation S11: Calculate degrees of activity of users at various time points using the user activity data.

Sub-operation S12: Set time periods of recommendation based on the degrees of activity associated with the various time points.

In implementations, the user activity log is statistically analyzed to obtain degrees of activity of users as a whole on the e-commerce platform at various time points. A degree of activity can reflect purchase demands of the users to a certain extent. Therefore, such indicator as degrees of activity can be used to analyze appropriate time periods of recommendation.

A degree of activity can be a ratio between the number of users who conduct clicking activities on an e-commerce platform at each time point and the total number of users on the e-commerce platform. Apparently, besides using the number of users who conduct clicking activities, respective ratios of the number of users who conduct collection activities, browsing activities, and adding-to-shopping-cart activities, to the total number of users may be used as a degree of activity of the users. The present disclosure does not have limitation thereon. A degree of activity that is calculated using only clicking activities may also be called a click rate. According to a distribution of degrees of activity in a certain period of time, time periods of recommendation are further set up.

In practice, when time periods of recommendation are set, in order to facilitate users to remember and meet the obsessive requirements of some users with respect to integers, the time periods of recommendation can be set as a full hour to a full hour, for example, 0-1 o'clock, 2-3 o'clock.

Operation 103: Individually configure recommendation strategies for the time periods of recommendation.

In real life, a user's demand for purchasing products changes with time. As purchasing demands are different in different time periods, adaptive recommendation strategies are needed to be configured so as to provide a user with products that meet his/her purchasing demand. In an example of the present disclosure, recommendation strategies may be set by an operator. A model of each time period of recommendation is obtained through machine learning, and is placed on an e-commerce platform to serve a user and to provide the user with products that meet his or her needs. The recommendation strategies can also be adjusted in turn based on the user activity data.

Operation 104: Adopt the recommendation strategies correspondingly to recommend service objects to users in the time periods of recommendation.

After a user enters the e-commerce platform, a time period of recommendation to which a current system time of the user belongs is determined. Products are then recommended to the user according to a recommendation strategy corresponding to that time period of recommendation.

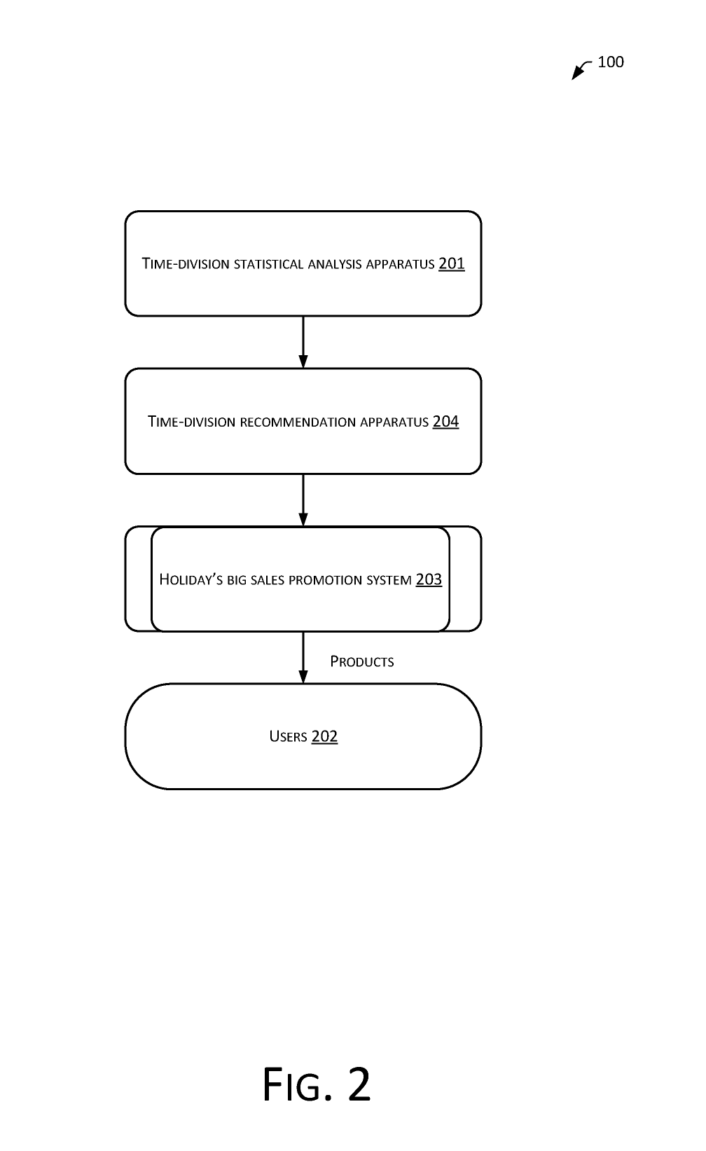

The embodiments of the present disclosure are particularly applicable to shopping promotions during festivals, which can increase shopping desires of users. Referring to a flowchart of a holiday product promotion 200 in accordance with the present disclosure as shown in FIG. 2, a process of performing a holiday product promotion 200 may include the following:

(1) Collecting user activity logs offline, entering a “time-division statistical analysis apparatus” 201, and statistically analyzing purchasing demands of users 202 at different time points, thereby outputting a series of strategies corresponding to each time period of recommendation. For example, a purchasing demand of users 202 in a certain day may be: i: 0-2 o'clock, a phase in which users scramble to buy; ii: 3-7 o'clock, a phase in which users make random purchases; iii: 8-18 o'clock, a phase in which users steadily make purchases; iv: 19-24 o'clock, a phase in which users are unwilling to buy.

(2) Entering a “time-division recommendation apparatus” 201 to recommend products to a “holiday's big sales promotion system” 203. The “holiday's big sales promotion system” 203 is a container, which can use various marketing strategies. The “time-division recommendation apparatus” 203 is provided with a recommendation strategy corresponding to each time period of recommendation. When a promotion event needs to be held, recommendation strategies in the “time-division recommendation apparatus” 204 are inputted into the “holiday's big sales promotion system” 203, and the “holiday's big sales promotion system” 203 starts to recommend products to users 202 according to the recommendation strategies.

In implementations, recommendation strategies are configured according to purchasing demands of users at different time periods. Recommendation strategies at different time periods may be as follows:

First stage: Users all rush to buy products, and products that a user has browsed/clicked/added items in a shopping cart within the recent one day, together with hot selling products within two hours, are recommended.

Second stage: After a user has completed a purchase and is upset, products that the user has browsed/clicked/added items in a shopping cart within the past one week are recommended.

Third stage: The scope of recommendation of product matching is expanded to meet everyone's loitering situation at work, and certain random factors are considered when products are recommended.

Fourth stage: The holiday's big sales promotion event is about to end, and products of daily consumer categories are weighted+products of long-term activity preferences of a user.

It should be noted that both the time periods of recommendation and the recommendation strategies can be adjusted. When the embodiments of the present disclosure are implemented, the time periods of recommendation may be divided and recommendation strategies according to actual situations may be formulated. For example, the above recommendation strategies of four stages may be adjusted. The embodiments of the present disclosure do not have any limitation thereon.

In order for one skilled in the art to understand the above recommendation strategies of four stages according to the embodiments of the present disclosure in a better manner, particular examples are used hereinafter for illustration.

(1) The recommendation strategies of the first stage and the second stage may be summarized as sub-operations of operation 104 as shown in FIG. 1C.

Sub-operation S21: Obtain user activity data of a certain user during a first specified time period, the user belonging to one or more user groups.

Sub-operation S22: Determine first recommended object(s) according to the user activity data.

Sub-operation S23: Determine second recommended object(s) of the user group(s) in a second specified time period.

Sub-operation S24: Recommend the first recommended object(s) and the second recommended object(s) to the user in a time period of recommendation.

In implementations, determining the first recommended object(s) according to the user activity data, i.e., sub-operation S22, may include the following sub-operations:

Sub-operation a1: Obtain service object(s) corresponding to the user activity data.

Sub-operation a2: Set the service object(s) as the first recommended object(s).

In implementations, determining the second recommended object(s) of the user group(s) at the second specified time period, i.e., sub-operation S23, may include the following sub-operations:

Sub-operation 131: Obtain user activity data of the user group(s) at a second specified time period.

Sub-operation b2: Count the number of service objects corresponding to the user activity data.

Sub-operation b3: Set the first N number of service objects as the second recommended object(s), N being a positive integer.

The recommendation strategies of the first stage and the second stage are mainly used for recommending a user with products that the user has interacted with during a specified period of time, and products that are purchased by the user's group(s) during a specified period of time. Specifically, in the first stage, product(s) that is/are browsed/clicked/added into a shopping cart since yesterday are taken as the first recommended object(s), and hot selling product(s) within two hours is/are recommended as the second recommended object(s) to the user. By the same token, in the second stage, product(s) that is/are browsed/clicked/added into a shopping cart since last week are taken as the first recommended object(s), and hot selling product(s) since yesterday is/are recommended as the second recommended object(s) to the user.

Users in an e-commerce platform will all belong to one or more user groups. A demarcation of the user groups can be made based on basic data of the users. For example, a demarcation is made based on an age, or whether a user is married. To which groups users belong is all based on a demarcation of user groups that is made in advance using basic data of the users (and apparently can also be made based on user activity data). The e-commerce platform counts the number of purchases of products purchased by each user group during a certain period of time and ranks them in an order according to the number of purchases. Products that are usually ranked in the top N positions are considered to be hot selling products.

(2) The recommendation strategy the third stage is summarized as sub-operations of operation 104 as shown in FIG. 1D:

Sub-operation S31: Obtain user activity data of a certain user during a third specified time period.

Sub-operation S32: Determine third recommended object(s) according to the user activity data.

Sub-operation S33: Randomly obtain fourth recommended object(s) from a preset object database.

Sub-operation S34: Recommend the third recommended object(s) and the fourth recommended object(s) to the user in a time period of recommendation.

The recommendation strategy of the third stage is mainly to use products that a user has browsed/clicked/added into a shopping cart in the past two weeks as third recommended objects, and products selected by the e-commerce platform according to random factor(s) as fourth recommended objects for recommending to the user.

A random factor refers to a random selection of products that have never been viewed by a user from a preset product base of an e-commerce platform to satisfy the newness of the user. For example, for a 20-year-old girl, the e-commerce platform mainly recommends products that she has interacted with in the past two weeks, plus some items that are randomly selected from the preset product base, such as cosmetics, children's clothes, etc., that may be used after work.

(3) The recommendation strategy of the fourth stage is summarized as sub-operations of operation 104 as shown in FIG. 1E:

Sub-operation S41: Obtain user activity data of a certain user in a fourth specified time period, the user activity data having corresponding service object(s).

Sub-operation S42: Determine fifth recommended object(s) using the service object(s) according to a preset collaborative filtering algorithm.

Sub-operation S43: Obtain preset commonly used service object(s) as sixth recommended object(s).

Sub-operation S44: Recommend the fifth recommended object(s) and the sixth recommended object(s) to the user in the time period of recommendation.

The recommendation strategy of the fourth phase is mainly to add weights to daily consumer products to increase respective probabilities of selecting these products. These products are used as sixth recommended objects. Furthermore, a user activity log of a user in the past six months is used to analyze preferences of the user and to select products as fifth recommended objects for recommending to the user. It can be understood that products which have a large number of interactive activities with the user are products that are more consistent with long-term activity preferences of the user. In general, a personalized recommendation method can be used in a process of determining a user preference.

Currently, a commonly used personalized recommendation method in the industry is a Collaborative Filtering (CF) based technology. Collaborative filtering is to analyze interests of a user to find products that are similar to a product of interest to the user or users who are similar (of interest) to the user in a user group, and integrate these similar users or similar products to form a prediction of a degree of interest of the user with respect to these products. Collaborative filtering may specifically include the following methods. In the following description, Item represents a product, and User represents a user.

(1) The most commonly used method is an Item-based collaborative filtering method, i.e., degrees of similarity between items are obtained through interaction data between User and Item. A core principle is that to cast a vote on a degree of similarity between Item A and Item B if User clicks or interacts with Item A and Item B at the same time. As such, degrees of similarity between items can be finally determined through a large amount of interactive activity data.

(2) Another type is User-based collaborative filtering method. A core principle is to directly use Item that User B has interacted with as a recommended Item for User A if User A is a User similar to User B. A determination of a degree of similarity between User A and User B often uses User's interaction Item vector, i.e., calculating a cosine angle between the two Item vectors. Intuitively speaking, the more Items that the two interact with in common are, the more similar the two are.

(3) In addition, there is another method based on Item that User interacts with that obtains the title (subject) of the Item or information in the details to obtain the User's favorite terms to represent the User, to build an inverted list of term-Item at the backend, to generate User's favorite terms online according to the inverted list, and to present in a way of recalling Item using the favorite terms.

It should be noted that the foregoing collaborative filtering methods are merely examples. In practice, other algorithms may be used to perform personalized recommendation for a user, which is not limited in implementations.

In implementations, degrees of activity of users at various time points are calculated using user activity log. Since the degrees of activity can reflect purchasing mindsets and shopping habits of the users, time periods of recommendation can be set according to the degrees of activity. The time periods of recommendation are configured with adaptive recommendation strategies, and products can be recommended to a user in a corresponding time period of recommendation using a suitable recommendation strategy. Since the user's purchasing mindset and shopping habit are taken into consideration in implementations, in-depth needs of the user are met, and the effect of shopping experience of the user is improved, thus greatly increasing the sales volume of an e-commerce platform.

It should be noted that the method embodiments are all expressed as series of action combinations for the ease of description. However, one skilled in the art should understand that the embodiments of the present disclosure are not limited by sequences of actions that are described because, some operations may be performed in other orders or in parallel according to the embodiments of the present disclosure. Moreover, one skilled in the art should also understand that the embodiments described in the specification all belong to exemplary embodiments, and actions involved therein may not be necessarily required by the embodiments of the present disclosure.

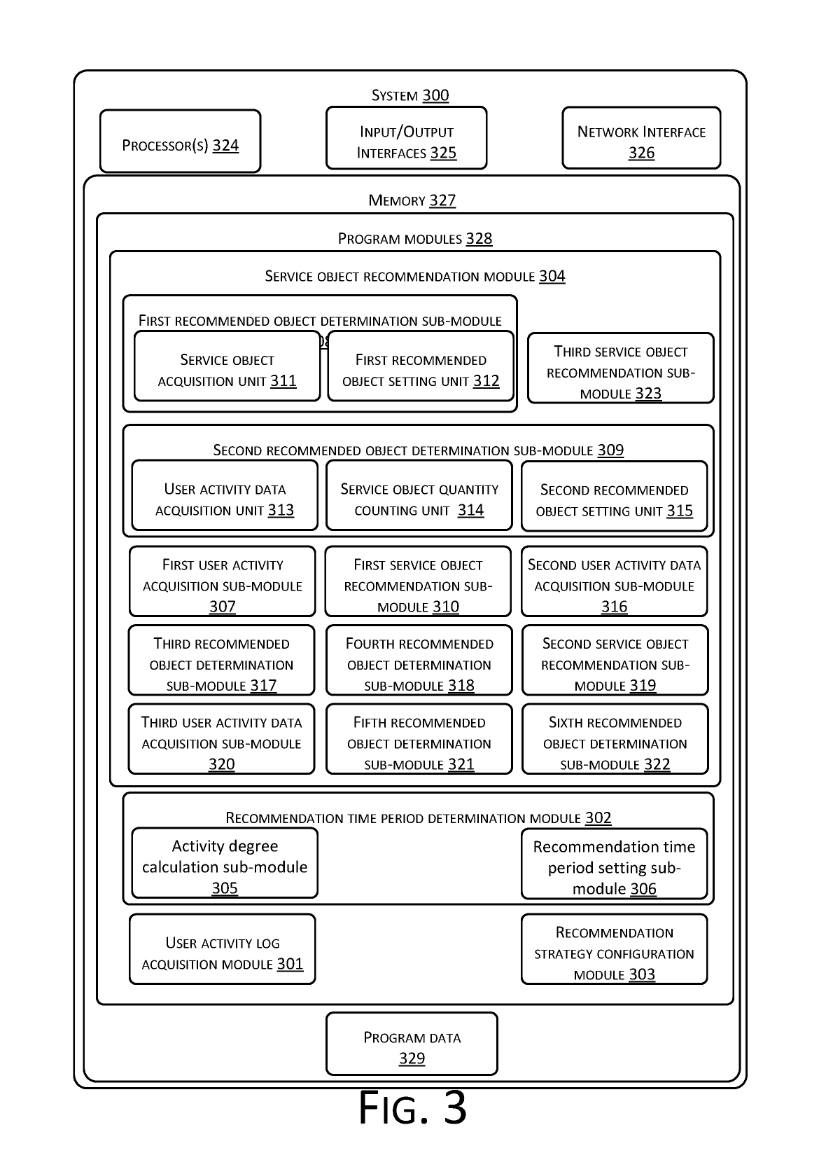

Referring to FIG. 3, a structural block diagram of an embodiment of a time-division recommendation system 300 for service objects in accordance with the present disclosure is shown. In implementations, the system 300 may include one or more computing devices. In implementations, the system 300 may be a part of one or more computing devices, e.g., implemented or run by the one or more computing devices. In implementations, the one or more computing devices may be located in a single place or distributed among a plurality of network devices over a network. In a typical configuration, a computing device includes one or more processors (CPU), an input/output interface, a network interface, and memory.

In implementations, the system 300 may include a user activity log acquisition module 301, a recommendation time period determination module 302, a recommendation strategy configuration module 303, and a service object recommendation module 304.

The user activity log acquisition module 301 is configured to obtain a user activity log on a service platform.

The recommendation time period determination module 302 is configured to determine time periods of recommendation using the user activity log.

In implementations, the user activity log includes user activity data, and the recommendation time period determination module 302 may include an activity degree calculation sub-module 305 configured to use the user activity data to calculate degrees of activity of the users at various time points; and a recommendation time period setting sub-module 306 configured to set the time periods of recommendation based on the degrees of activity of the respective time points.

The recommendation strategy configuration module 303 is configured to separately configure recommendation strategies for the time periods of recommendation.

The service object recommendation module 304 is configured to recommend service objects to users in the time periods of recommendation using the recommendation strategies correspondingly.

In implementations, the service object recommendation module 304 may include a first user activity acquisition sub-module 307 configured to obtain user activity data of a certain user during a first specified time period, the user belonging to one or more user groups; a first recommended object determination sub-module 308 configured to determine first recommended object(s) based on the user activity data; a second recommended object determination sub-module 309 configured to determine second recommended object(s) of the user groups at a second specified time period; and a first service object recommendation sub-module 310 configured to recommend the first recommended object(s) and the second recommended object(s) for the user in a time period of recommendation.

In implementations, the first recommended object determination sub-module 308 includes a service object acquisition unit 311 configured to obtain service object(s) corresponding to the user activity data; and a first recommended object setting unit 312 configured to set the service object(s) as the first recommended object(s).

In implementations, the second recommended object determination sub-module 309 includes a user activity data acquisition unit 313 configured to obtain user activity data of the user groups at the second specified time period; a service object quantity counting unit 314 configured to count a number of service objects corresponding to the user activity data; and a second recommended object setting unit 315 configured to set first N number of service objects as the second recommended object(s), N being a positive integer.

In implementations, the service object recommendation module 304 may include a second user activity data acquisition sub-module 316 configured to obtain user activity data of a certain user during a third specified time period; a third recommended object determination sub-module 317 configured to determine third recommended object(s) according to the user activity data; a fourth recommended object determination sub-module 318 configured to randomly obtain fourth recommended object(s) from a preset object database; and a second service object recommendation sub-module 319 configured to recommend the third recommended object(s) and the fourth recommended object(s) to the user in a time period of recommendation.

In implementations, the service object recommendation module 304 may include a third user activity data acquisition sub-module 320 configured to obtain user activity data of a certain user in a fourth specified period of time, the user activity data having corresponding service object(s); a fifth recommended object determination sub-module 321 configured to determine fifth recommended object(s) using the service object(s) according to a preset collaborative filtering algorithm; a sixth recommended object determination sub-module 322 configured to obtain preset common service object(s) as sixth recommended object(s); and a third service object recommendation sub-module 323 configured to recommend the fifth recommended object(s) and the sixth recommended object(s) to the user in a time period of recommendation.

In implementations, the system 300 may also include one or more processors 324, an input/output (I/O) interface 325, a network interface 326, and memory 327.

The memory 327 may include a form of computer readable media such as a volatile memory, a random access memory (RAM) and/or a non-volatile memory, for example, a read-only memory (ROM) or a flash RAM. The memory 327 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 327 may include program modules 328 and program data 329. The program modules 328 may include one or more of the foregoing modules, sub-modules, and units as described in FIG. 3.

In implementations, the service platform is an e-commerce platform, the service objects are products, and the user activity data includes clicking activity data of the user for the products, no-clicking activity data, browsing activity data, adding-to-shopping-cart activity data, and collection activity data, and flow data.

Due to their basic similarities to the method embodiments, the system embodiments are described in a relatively simple manner. Portions thereof can be referenced to related portions of the method embodiments.

Each embodiment in the present specification is described in a progressive manner. Each embodiment has a focus that is different from those of other embodiments. Same or similar parts among the embodiments can be referenced to each other.

One skilled in the art should understand that an embodiment of the present disclosure can be provided as a method, an apparatus, or a computer program product. Therefore, the embodiments of the present disclosure can be adopted in a form of a complete hardware embodiment, a complete software embodiment, or an embodiment of a combination of software and hardware. Furthermore, an embodiment of the present disclosure can be adopted in a form of a computer program product implemented by one or more computer usable storage media (which include, but are not limited to a magnetic storage device, CD-ROM, an optical storage device, etc.) including computer usable program codes.

The embodiments of the present disclosure is described with reference to flowcharts and/or block diagrams of the methods, terminal devices (systems), and computer program products according to the embodiments of the present disclosure. It should be understood that computer program instructions may be used to implement each process and/or block in the flowcharts and/or block diagrams and a combination of process(es) and/or block(s) in the flowcharts and/or the block diagrams. These computer program instructions may be provided to a general-purpose computer, a special-purpose computer, an embedded processor, or a processor of another programmable data processing terminal device to generate a machine, so that the instructions executed by a computer or a processor of another programmable data processing terminal device generate an apparatus for implementing function(s) specified in one or more processes in the flowcharts and/or in one or more blocks in the block diagrams.

These computer program instructions may also be stored in a computer readable storage device that can instruct a computer or another programmable data processing terminal device to perform operations in a particular manner, such that the instructions stored in the computer readable storage device generate an article of manufacture that includes an instruction apparatus. The instruction apparatus implements function(s) that is/are specified in one or more processes in the flowcharts and/or in one or more blocks in the block diagrams.

These computer program instructions may also be loaded onto a computer or another programmable data processing terminal device, such that a series of operations are performed on the computer or the other programmable terminal device, thereby generating computer-implemented processing. Therefore, the instructions executed on the computer or the other programmable terminal device provide a procedure for implementing function(s) specified in one or more processes in the flowcharts and/or in one or more blocks in the block diagrams.

Although exemplary embodiments in implementations have been described, one skilled in the art may perform other changes and modifications to these embodiments after knowing the basic inventive concept. Therefore, the appended claims are intended to be interpreted as including the exemplary embodiments and all the changes and modifications that fall into the scope of the embodiments of the present disclosure.

Finally, it should be further noted that relational terms such as “first” and “second” are only used for distinguishing one entity or operation from another entity or operation, and does not necessarily require or imply any of these relationships or ordering between these entities or operations in reality. Moreover, terms such as “include”, “contain” or other variations thereof are intended to cover non-exclusive inclusion, so that a process, method, article or terminal device including a series of elements not only includes the elements, but also includes other elements not explicitly listed, or further includes inherent elements of the process, method, article or terminal device. Without further restrictions, an element defined by a phrase “include a/an . . . ” does not exclude other same elements to exist in a process, method, article, or terminal device that includes the element.

A time-division recommendation method for service objects and a time-division recommendation apparatus for service objects that are provided in the present disclosure are described in detail above. Specific examples are used herein to illustrate the principles and implementations of the present disclosure, and the description of the above embodiments is merely used to help understand the methods of the present disclosure and the core ideas thereof. Furthermore, one of ordinary skill in the art may change the specific implementations and scopes of application based on the ideas of the present disclosure. In short, the content of the specification should not be construed as limitations to the present disclosure.

The present disclosure can be further understood using the following clauses.

Clause 1: A time-division recommendation method for service objects, comprising: obtaining a user activity log on a service platform; determining time periods of recommendation using the user activity log; separately configuring recommendation strategies for the time periods of recommendation; and recommending service objects to users in the time periods of recommendation using the recommendation strategies correspondingly.

Clause 2: The method of Clause 1, wherein the user activity log comprises user activity data, and determining the time periods of recommendation using the user activity log comprises: using the user activity data to calculate degrees of activity of the users at various time points; and setting the time periods of recommendation based on the degrees of activity of the respective time points.

Clause 3: The method of Clause 1 or 2, wherein recommending the service objects to the users in the time periods of recommendation using the recommendation strategies correspondingly comprises: obtaining user activity data of a certain user during a first specified time period, the user belonging to one or more user groups; determining first recommended object(s) based on the user activity data; determining second recommended object(s) of the user groups at a second specified time period; and recommending the first recommended object(s) and the second recommended object(s) for the user in a time period of recommendation.

Clause 4: The method of Clause 3, wherein determining the first recommended object(s) based on the user activity data comprises: acquiring service object(s) corresponding to the user activity data; and setting the service object(s) as the first recommended object(s).

Clause 5: The method of Clause 3, wherein determining the second recommended object(s) of the user groups at the second specified time period comprises: acquiring user activity data of the user groups at the second specified time period; counting a number of service objects corresponding to the user activity data; and setting first N number of service objects as the second recommended object(s), N being a positive integer.

Clause 6: The method of Clause 1 or 2, wherein recommending the service objects to the users in the time periods of recommendation using the recommendation strategies correspondingly comprises: obtaining user activity data of a certain user during a third specified time period; determining third recommended object(s) according to the user activity data; randomly obtaining fourth recommended object(s) from a preset object database; and recommending the third recommended object(s) and the fourth recommended object(s) to the user in a time period of recommendation.

Clause 7: The method of Clause 1 or 2, wherein recommending the service objects to the users in the time periods of recommendation using the recommendation strategies correspondingly comprises: obtaining user activity data of a certain user in a fourth specified period of time, the user activity data having corresponding service object(s); determining fifth recommended object(s) using the service object(s) according to a preset collaborative filtering algorithm; obtaining preset common service object(s) as sixth recommended object(s); and recommending the fifth recommended object(s) and the sixth recommended object(s) to the user in a time period of recommendation.

Clause 8: The method of Clause 1 or 2, wherein the service platform is an e-commerce platform, the service objects are products, and the user activity data includes clicking activity data of the user for the products, no-clicking activity data, browsing activity data, adding-to-shopping-cart activity data, and collection activity data, and flow data.

Clause 9: A time-division recommendation apparatus for service objects, comprising: a user activity log acquisition module configured to obtain a user activity log on a service platform; a recommendation time period determination module configured to determine time periods of recommendation using the user activity log; a recommendation strategy configuration module configured to separately configure recommendation strategies for the time periods of recommendation; and a service object recommendation module configured to recommend service objects to users in the time periods of recommendation using the recommendation strategies correspondingly.

Clause 10: The apparatus of Clause 9, wherein the user activity log comprises user activity data, and the recommendation time period determination module comprises: an activity degree calculation sub-module configured to use the user activity data to calculate degrees of activity of the users at various time points; and a recommendation time period setting sub-module configured to set the time periods of recommendation based on the degrees of activity of the respective time points.

Clause 11: The apparatus of Clause 9 or 10, wherein the service object recommendation module comprises: a first user activity acquisition sub-module configured to obtain user activity data of a certain user during a first specified time period, the user belonging to one or more user groups; a first recommended object determination sub-module configured to determine first recommended object(s) based on the user activity data; a second recommended object determination sub-module configured to determine second recommended object(s) of the user groups at a second specified time period; and a first service object recommendation sub-module configured to recommend the first recommended object(s) and the second recommended object(s) for the user in a time period of recommendation.

Clause 12: The apparatus of Clause 11, wherein the first recommended object determination sub-module comprises: a service object acquisition unit configured to obtain service object(s) corresponding to the user activity data; and a first recommended object setting unit configured to set the service object(s) as the first recommended object(s).

Clause 13: The apparatus of Clause 11, wherein the second recommended object determination sub-module comprises: a user activity data acquisition unit configured to obtain user activity data of the user groups at the second specified time period; a service object quantity counting unit configured to count a number of service objects corresponding to the user activity data; and a second recommended object setting unit configured to set first N number of service objects as the second recommended object(s), N being a positive integer.

Clause 14: The apparatus of Clause 9 or 10, wherein the service object recommendation module comprises: a second user activity data acquisition sub-module configured to obtain user activity data of a certain user during a third specified time period; a third recommended object determination sub-module configured to determine third recommended object(s) according to the user activity data; a fourth recommended object determination sub-module configured to randomly obtain fourth recommended object(s) from a preset object database; and a second service object recommendation sub-module configured to recommend the third recommended object(s) and the fourth recommended object(s) to the user in a time period of recommendation.

Clause 15: The apparatus of Clause 9 or 10, wherein the service object recommendation module comprises: a third user activity data acquisition sub-module configured to obtain user activity data of a certain user in a fourth specified period of time, the user activity data having corresponding service object(s); a fifth recommended object determination sub-module configured to determine fifth recommended object(s) using the service object(s) according to a preset collaborative filtering algorithm; a sixth recommended object determination sub-module configured to obtain preset common service object(s) as sixth recommended object(s); and a third service object recommendation sub-module configured to recommend the fifth recommended object(s) and the sixth recommended object(s) to the user in a time period of recommendation.

What is claimed is:

1. A method implemented by one or more computing devices, the method comprising:
obtaining a user activity log on a service platform;
determining time periods of recommendation using the user activity log;
separately configuring recommendation strategies for the time periods of recommendation; and
recommending service objects to users in the time periods of recommendation using the recommendation strategies correspondingly.

2. The method of claim 1, wherein the user activity log comprises user activity data, and determining the time periods of recommendation using the user activity log comprises:
using the user activity data to calculate degrees of activity of the users at various time points; and
setting the time periods of recommendation based on the degrees of activity of the respective time points.

3. The method of claim 1, wherein recommending the service objects to the users in the time periods of recommendation using the recommendation strategies correspondingly comprises:
obtaining user activity data of a certain user during a first specified time period, the user belonging to one or more user groups;
determining one or more first recommended objects based on the user activity data;
determining one or more second recommended objects of the user groups at a second specified time period; and
recommending the one or more first recommended objects and the one or more second recommended objects for the user in a time period of recommendation.

4. The method of claim 3, wherein determining the first recommended object(s) based on the user activity data comprises:
acquiring one or more service objects corresponding to the user activity data; and
setting the one or more service objects as the one or more first recommended objects.

5. The method of claim 3, wherein determining the one or more second recommended objects of the user groups at the second specified time period comprises:
acquiring user activity data of the user groups at the second specified time period;
counting a number of service objects corresponding to the user activity data; and
setting first N number of service objects as the one or more second recommended objects, N being a positive integer.

6. The method of claim 1, wherein recommending the service objects to the users in the time periods of recommendation using the recommendation strategies correspondingly comprises:
obtaining user activity data of a certain user during a third specified time period;
determining one or more third recommended objects according to the user activity data;
randomly obtaining one or more fourth recommended objects from a preset object database; and
recommending the one or more third recommended objects and the one or more fourth recommended objects to the user in a time period of recommendation.

7. The method of claim 1, wherein recommending the service objects to the users in the time periods of recommendation using the recommendation strategies correspondingly comprises:
obtaining user activity data of a certain user in a fourth specified period of time, the user activity data having one or more corresponding service objects;
determining one or more fifth recommended objects using the one or more service objects according to a preset collaborative filtering algorithm;
obtaining preset common service object(s) as one or more sixth recommended objects; and
recommending the one or more fifth recommended objects and the one or more sixth recommended objects to the user in a time period of recommendation.

8. The method of claim 1, wherein the service platform is an e-commerce platform, the service objects are products, and the user activity data includes clicking activity data of the user for the products, no-clicking activity data, browsing activity data, adding-to-shopping-cart activity data, and collection activity data, and flow data.

9. An apparatus comprising:
one or more processors;
memory;
a user activity log acquisition module stored in the memory and executable by one or more processors to obtain a user activity log on a service platform;
a recommendation time period determination module stored in the memory and executable by one or more processors to determine time periods of recommendation using the user activity log;
a recommendation strategy configuration module stored in the memory and executable by one or more processors to separately configure recommendation strategies for the time periods of recommendation; and
a service object recommendation module stored in the memory and executable by one or more processors to recommend service objects to users in the time periods of recommendation using the recommendation strategies correspondingly.

10. The apparatus of claim 9, wherein the user activity log comprises user activity data, and the recommendation time period determination module comprises:
an activity degree calculation sub-module configured to use the user activity data to calculate degrees of activity of the users at various time points; and
a recommendation time period setting sub-module configured to set the time periods of recommendation based on the degrees of activity of the respective time points.

11. The apparatus of claim 9, wherein the service object recommendation module comprises:
a first user activity acquisition sub-module configured to obtain user activity data of a certain user during a first specified time period, the user belonging to one or more user groups;
a first recommended object determination sub-module configured to determine one or more first recommended objects based on the user activity data;
a second recommended object determination sub-module configured to determine one or more second recommended objects of the user groups at a second specified time period; and
a first service object recommendation sub-module configured to recommend the one or more first recommended objects and the one or more second recommended objects for the user in a time period of recommendation.

12. The apparatus of claim 11, wherein the first recommended object determination sub-module comprises:
a service object acquisition unit configured to obtain one or more service objects corresponding to the user activity data; and
a first recommended object setting unit configured to set the one or more service objects as the one or more first recommended objects.

13. The apparatus of claim 11, wherein the second recommended object determination sub-module comprises:
a user activity data acquisition unit configured to obtain user activity data of the user groups at the second specified time period;
a service object quantity counting unit configured to count a number of service objects corresponding to the user activity data; and
a second recommended object setting unit configured to set first N number of service objects as the one or more second recommended objects, N being a positive integer.

14. The apparatus of claim 9, wherein the service object recommendation module comprises:
a second user activity data acquisition sub-module configured to obtain user activity data of a certain user during a third specified time period;
a third recommended object determination sub-module configured to determine one or more third recommended objects according to the user activity data;
a fourth recommended object determination sub-module configured to randomly obtain one or more fourth recommended objects from a preset object database; and
a second service object recommendation sub-module configured to recommend the one or more third recommended objects and the one or more fourth recommended objects to the user in a time period of recommendation.

15. The apparatus of claim 9, wherein the service object recommendation module comprises:
a third user activity data acquisition sub-module configured to obtain user activity data of a certain user in a fourth specified period of time, the user activity data having corresponding one or more service objects;
a fifth recommended object determination sub-module configured to determine one or more fifth recommended objects using the one or more service objects according to a preset collaborative filtering algorithm;
a sixth recommended object determination sub-module configured to obtain preset common service objects as one or more sixth recommended objects; and
a third service object recommendation sub-module configured to recommend the one or more fifth recommended objects and the one or more sixth recommended objects to the user in a time period of recommendation.

16. One or more computer readable media storing executable instructions that, when executed by one or more processors, cause the one or more processors to perform acts comprising:
obtaining a user activity log on a service platform;
determining time periods of recommendation using the user activity log;
separately configuring recommendation strategies for the time periods of recommendation; and
recommending service objects to users in the time periods of recommendation using the recommendation strategies correspondingly.

17. The one or more computer readable media of claim 16, wherein the user activity log comprises user activity data, and determining the time periods of recommendation using the user activity log comprises:
using the user activity data to calculate degrees of activity of the users at various time points; and
setting the time periods of recommendation based on the degrees of activity of the respective time points.

18. The one or more computer readable media of claim 16, wherein recommending the service objects to the users in the time periods of recommendation using the recommendation strategies correspondingly comprises:
obtaining user activity data of a certain user during a first specified time period, the user belonging to one or more user groups;
determining one or more first recommended objects based on the user activity data;
determining one or more second recommended objects of the user groups at a second specified time period; and
recommending the one or more first recommended objects and the one or more second recommended objects for the user in a time period of recommendation.

19. The one or more computer readable media of claim 18, wherein determining the first recommended object(s) based on the user activity data comprises:
acquiring one or more service objects corresponding to the user activity data; and
setting the one or more service objects as the one or more first recommended objects.

20. The one or more computer readable media of claim 18, wherein determining the one or more second recommended objects of the user groups at the second specified time period comprises:
acquiring user activity data of the user groups at the second specified time period;
counting a number of service objects corresponding to the user activity data; and
setting first N number of service objects as the one or more second recommended objects, N being a positive integer.
